(19) United States
(12) Patent Application Publication
(10) Pub. No.: US 2025/0027463 A1
(43) Pub. Date: Jan. 23, 2025

(54) CANISTER

(71) Applicant: FUTABA INDUSTRIAL CO., LTD., Okazaki-shi (JP)

(72) Inventor: Akira Asano, Okazaki-shi (JP)

(21) Appl. No.: 18/764,694

(22) Filed: Jul. 5, 2024

(30) Foreign Application Priority Data
Jul. 18, 2023 (JP) 2023-116772

(51) Int. Cl. F02M 25/08

(52) U.S. Cl. CPC F02M 25/0854

(57) ABSTRACT

A canister includes at least one chamber in which an adsorbent configured to adsorb an evaporated fuel is placed, an inflow port, an atmosphere port, an outflow port, and a case. The case forms a particular chamber in which a granular adsorbent is placed. The particular chamber is one of the at least one chamber. The case includes a side wall and at least one protrusion. The side wall extends from a first end of the particular chamber to a second end of the particular chamber in flow directions, and forms an inner peripheral surface of the particular chamber. At least one protrusion is a part that is formed integrally with the side wall and protrudes from an inner peripheral surface of the side wall.

### CROSS-REFERENCE TO RELATED APPLICATIONS

The present disclosure claims the benefit of Japanese Patent Application No. 2023-116772 filed on Jul. 18, 2023 with the Japan Patent Office, the disclosure of which is incorporated herein in its entirety by reference.

### BACKGROUND

The present disclosure relates to a canister.

As disclosed in Japanese Unexamined Patent Application Publication Nos. 2022-164344 (JP2022-164344) and 2022-164345 (JP2022-164345), there has been a known technique of arranging a member including two or more rod-like portions extending in the same direction inside a chamber in a canister where a granular adsorbent is placed. According to such a technique, a gap is formed between each rod-like portion of the member and the granular adsorbent placed in the chamber. As a result, ventilation resistance is reduced.

### SUMMARY

In the chamber in the canister, a fluid flow tends to be stagnant in the vicinity of a wall surface of a case forming the chamber. To address this tendency, techniques disclosed in JP2022-164344 and JP 2022-164345 place a rod-like portion predominantly at the center of a chamber. Moreover, the rod-like portion is formed as a separate member from a case. That is, these techniques pose a possibility that the number of components configuring the canister increases.

In one aspect of the present disclosure, it is desirable to reduce ventilation resistance while preventing increase in the number of components.

One aspect of the present disclosure provides a canister configured to be mounted in a vehicle with an engine. The canister comprises at least one chamber, an inflow port, an atmosphere port, an outflow port, and a case. In the at least one chamber, there is placed an adsorbent configured to adsorb an evaporated fuel. The inflow port is configured to cause the evaporated fuel to flow from a fuel tank of the vehicle into the at least one chamber. The atmosphere port is configured to be open to atmosphere. The outflow port is configured to cause the evaporated fuel adsorbed on the adsorbent to flow out towards the engine by utilizing the atmosphere flowing in through the atmosphere port. The case forms a particular chamber in which a granular adsorbent is placed. The particular chamber is one of the at least one chamber. The case includes a side wall and at least one protrusion. The side wall extends from a first end of the particular chamber to a second end of the particular chamber in flow directions of a fluid, and forms an inner peripheral surface of the particular chamber. The at least one protrusion is a part formed integrally with the side wall, and protrudes from an inner peripheral surface of the side wall.

In the above-described configuration, there is a gap formed in the vicinity of the inner peripheral surface of the particular chamber between the at least one protrusion formed integrally with the side wall and the granular adsorbent. Thus, the above-described configuration can encourage a fluid flow in the vicinity of the inner peripheral surface. Accordingly, such a configuration can reduce ventilation resistance in the canister while preventing increase in the number of components.

In one aspect of the present disclosure, one of the atmosphere port, or the inflow port and the outflow port may be provided at the first end of the particular chamber. The at least one protrusion may extend along the flow directions from the first end of the particular chamber.

The above-described configuration can further encourage the fluid flow in the vicinity of the inner peripheral surface of the particular chamber. Accordingly, the ventilation resistance in the canister can be reduced.

In one aspect of the present disclosure, the at least one protrusion may extend linearly.

Such a configuration can satisfactorily reduce the ventilation resistance in the canister.

In one aspect of the present disclosure, the canister may further comprise an outer case. The outer case is a member forming an outer peripheral surface of the canister, and is provided therein with the at least one chamber. The case may be a member arranged inside the outer case.

The above-described configuration can reduce the ventilation resistance in the canister while preventing increase in the number of components. In one aspect of the present disclosure, two or more protrusions are arranged in an aligned manner in the inner peripheral surface of the side wall so as to circle around the particular chamber.

The above-described configuration can further encourage the fluid flow in the vicinity of the inner peripheral surface. Accordingly, the ventilation resistance can be further reduced.

In one aspect of the present disclosure, one of the atmosphere port, or the inflow port and the outflow port may be provided at the first end of the particular chamber. The at least one protrusion may have a height, from the inner peripheral surface to a top of the at least one protrusion, higher towards the first end.

In a chamber provided with a port, an area having a relatively satisfactory fluid flow is considered to expand substantially in the form of a fan from the port along the flow directions of the fluid. In contrast, the above-described configuration enables arrangement of the protrusion in an area having a relatively poor fluid flow and can therefore encourage the fluid flow in this area. Accordingly, the ventilation resistance in the canister can be further reduced.

In one aspect of the present disclosure, one of the atmosphere port, or the inflow port and the outflow port may be provided at the first end of the particular chamber. The side wall may include a reduced part located in the vicinity of the first end of the particular chamber. The reduced part may be configured such that a cross-sectional area of the particular chamber orthogonal to the flow directions is reduced towards the first end. The at least one protrusion may be provided to the reduced part.

In the above-described configuration, due to the shape of the reduced part as well as the two or more protrusions, the fluid flow is encouraged inside the reduced part in the particular chamber. Accordingly, the ventilation resistance in the canister can be further reduced.

In one aspect of the present disclosure, the at least one protrusion may extend at least from a first end of the reduced part to a second end of the reduced part in the flow directions.

Such a configuration can satisfactorily reduce the ventilation resistance in the canister.

### BRIEF DESCRIPTION OF THE DRAWINGS

Example embodiments of the present disclosure will be described hereinafter with reference to the accompanying drawings, in which:

FIG. 1 is a sectional view of a canister according to a first embodiment along flow directions of a fluid;

FIG. 2 is a sectional view of a first chamber in the canister according to the first embodiment orthogonal to the flow directions of the fluid;

FIG. 3 is a sectional perspective view of a protrusion in the canister according to the first embodiment;

FIG. 4 is a sectional perspective view of the protrusion in the canister according to the first embodiment;

FIG. 5 is a sectional perspective view of the protrusion in the canister according to the first embodiment;

FIG. 6 is a sectional view of a canister according to a second embodiment along the flow directions of the fluid;

FIG. 7 is a sectional view of a reduced part in the canister according to a third embodiment along the flow directions of the fluid;

FIG. 8 is a sectional view of a reduced part according to a modified embodiment along the flow directions of the fluid;

FIG. 9 is a sectional view of a reduced part according to a modified embodiment along the flow directions of the fluid; and

FIG. 10 is a sectional view of a reduced part according to a modified embodiment along the flow directions of the fluid.

### DETAILED DESCRIPTION OF EXEMPLARY EMBODIMENTS

Embodiments of the present disclosure are not limited to embodiments to be described below, and can be variously modified within the technical scope of the present disclosure.

### 1. First Embodiment

### (1) Configuration of Canister

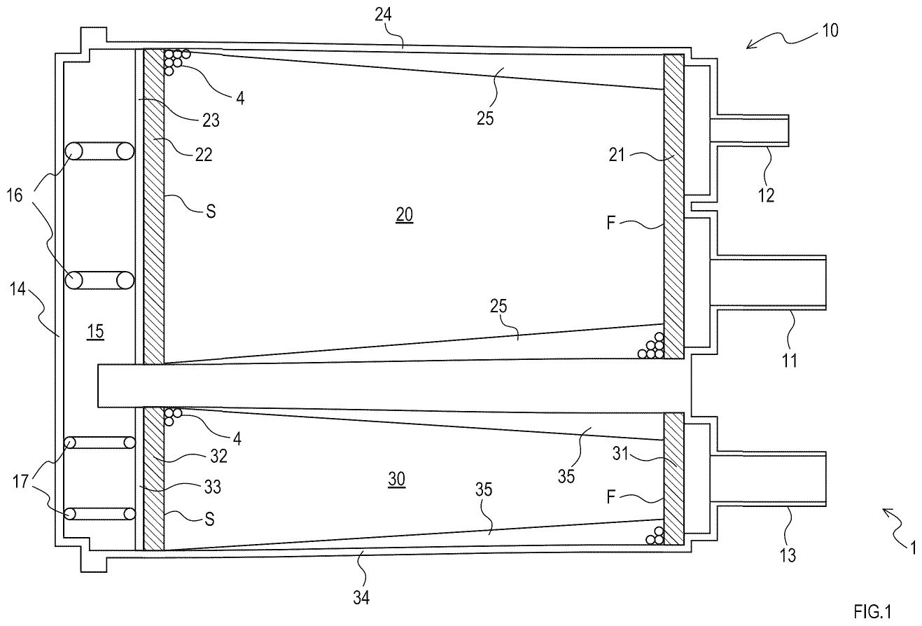

There is provided a canister 1 in an embodiment. The canister 1 is mounted in a vehicle (see, FIG. 1). The canister 1 includes an outer case 10 that forms an outer peripheral surface of the canister 1 and is made of resin. There are provided a first chamber 20 and a second chamber 30 inside the outer case 10. In these chambers, an adsorbent 4 is placed so as to adsorb an evaporated fuel. It should be noted that the number of chambers in the canister 1 may be one, or three or more, for example.

At an end of the outer case 10, there are provided an inflow port 11, an outflow port 12, and an atmosphere port 13. Hereinafter, a side of the outer case 10 of the canister 1 on which the inflow port 11, the outflow port 12, and the atmosphere port 13 are provided is referred to as “port side”. Furthermore, the outer case 10 includes an opening on an opposite side to the port side. The opening is closed by a lid 14. Hereinafter, the opposite side to the port side (in other words, a side on which the lid 14 is provided) is referred to as “lid side”.

The first chamber 20 includes a space that has a substantially rectangular parallelepiped shape extending from the port side to the lid side. The first chamber 20 is provided with, at an end on the port side (hereinafter, “first end F”) thereof, the inflow port 11 and the outflow port 12 that connect the first chamber 20 and the outside of the canister 1. It should be noted that the shape of the space inside the first chamber 20 is not limited to the substantially rectangular parallelepiped shape, and may be a cylindrical shape, for example. Furthermore, there are arranged filters 21 and 22, respectively, at the first end F and an end on the lid side (hereinafter, “second end S”) of the first chamber 20. Between the filters 21 and 22, the adsorbent 4 is placed. The first chamber 20 is connected to a communicating path 15 at the second end S thereof. Furthermore, between the filter 22 on the lid side of the first chamber 20 and the communicating path 15, there is arranged a porous plate 23 having permeability. Between the porous plate 23 and the lid 14, there is arranged a coil spring 16. The coil spring 16 presses the porous plate 23 towards the port side.

The second chamber 30 is adjacent to the first chamber 20. The second chamber 30 has a smaller volume than that of the first chamber 20. The second chamber 30 has an elongated cylindrical shape extending from the lid side to the port side. It should be noted that the shape of the second chamber 30 is not limited to be cylindrical, and may be in the form of a prism, for example. At an end on the port side (hereinafter, “first end F”) of the second chamber 30, there is provided the atmosphere port 13 that connects the second chamber 30 and the outside of the canister 1. As in the first chamber 20, there are arranged filters 31 and 32, respectively, at the first end F and an end on the lid side (hereinafter, “second end S”) of the second chamber 30. Between the filters 31 and 32, the adsorbent 4 is placed. Furthermore, the second chamber 30 is connected to the communicating path 15 at the second end S thereof. Between the filter 32 on the lid side and the communicating path 15, there is arranged a porous plate 33. As in the first chamber 20, the porous plate 33 is pressed towards the port side with a coil spring 17 located between the porous plate 33 and the lid 14.

The communicating path 15 is arranged along the lid 14, and connects the first chamber 20 and the second chamber 30. Therefore, a fluid can travel back and forth inside the canister 1 between the first chamber 20 and the second chamber 30 via the communicating path 15.

The inflow port 11 is connected to a fuel tank of an engine of the vehicle. The evaporated fuel originating in the fuel tank flows into the canister 1 via the inflow port 11, and is adsorbed on the adsorbent 4 in each chamber. Consequently, fuel is accumulated inside the canister 1.

The outflow port 12 is connected to an intake pipe of the engine of the vehicle; and the atmosphere port 13 communicates with the outside of the vehicle, and is open to the atmosphere. The negative intake air pressure of the engine causes atmospheric air (in other words, purge air) to flow into the canister 1 via the atmosphere port 13. Such inflow of the purge air causes the evaporated fuel adsorbed on the adsorbent 4 to be desorbed, and the desorbed evaporated fuel flows out together with the purge air through the outflow port 12 towards the intake pipe. In this way, purging to remove the evaporated fuel adsorbed on the adsorbent 4 is carried out, and the adsorbent 4 is recovered.

In the first and second chambers 20 and 30, the evaporated fuel and the purge air (hereinafter, also referred to as “fluid”) flow along directions in which the first ends F and the second ends S face each other.

### (2) Protrusion

The first and second chambers 20 and 30 are configured as particular chambers provided with two or more protrusions 25 and 35 on side walls 24 and 34, respectively (see, FIG. 1). It should be noted that one of the first or second chamber 20 or 30 may be configured as the particular chamber.

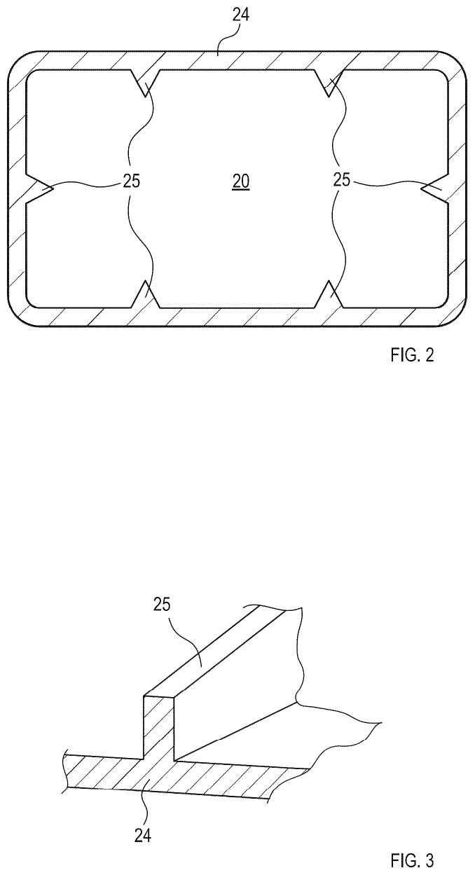

A part of the outer case 10 configuring the first chamber 20 includes the side wall 24 (see, FIG. 2). The side wall 24 extends from the first end F to the second end S of the first chamber 20, laterally surrounds the first chamber 20, and forms an inner peripheral surface of the first chamber 20. Similarly, there is provided the side wall 34 in a part of the outer case 10 configuring the second chamber 30.

In the side walls 24 and 34, respectively, the two or more protrusions 25 and 35 are provided so as to protrude from the inner peripheral surfaces. The side walls 24 and 34 are made of resin, and formed integrally with the outer case 10. The two or more protrusions 25 and 35 are also made of resin, and formed integrally with the side walls 24 and 34 and thus, the outer case 10. That is, the two or more protrusions 25 and 35 of the side walls 24 and 34 are formed as a part of the outer case 10 when the outer case 10 is formed through, for example, injection molding.

Each protrusion 25 in the first chamber 20 is an elongated portion formed like a rib, and extends linearly along flow directions of the fluid from the first end F towards the second end S of the first chamber 20 (in other words, towards the lid side). However, each protrusion 25 does not necessarily extend linearly. For example, each protrusion 25 may extend towards the lid side in a bent manner or curved manner, or extend in a direction different from the flow directions of the fluid such as a direction orthogonal to the flow directions. Furthermore, in one example, each protrusion 25 extends from the first end F to the second end S. However, each protrusion 25 may not reach the second end S. An end on the lid side of each protrusion 25 may be located, for example, in the vicinity of the center of the side wall 24 in the flow directions of the fluid or the first end F. Still further, each protrusion 25 may extend from a position apart from the first end F. Still further, each protrusion 25 may be a rod-shaped portion protruding from the inner peripheral surface of the side wall 24.

The two or more protrusions 25 are arranged in an aligned manner at substantially fixed intervals so as to circle around a lateral surface of the first chamber 20. Needless to say, the arrangement of the two or more protrusions 25 is not limited hereto. An interval between adjacent protrusions 25 may not be substantially fixed. Furthermore, the two or more protrusions 25 may be located at particular positions in the inner peripheral surface of the side wall 24 without circling around the lateral surface of the first chamber 20.

Each protrusion 25 has a height higher towards the first end F. It should be noted that the height means a length of the protrusion 25 in a protruding direction between a top of the protrusion 25 and the inner peripheral surface of the side wall 24. Needless to say, the height of each protrusion 25 is not limited hereto, and may be substantially fixed or higher towards the second end S.

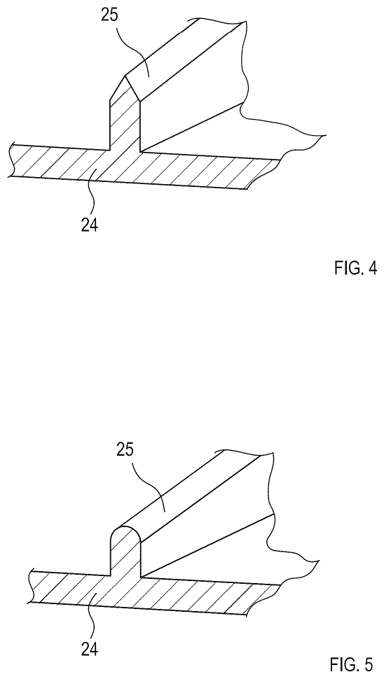

In one example, each protrusion 25 has a substantially polygonal shape in a cross-section orthogonal to an extending direction (in other words, the flow directions of the fluid) thereof. Specifically, the cross-section may be a triangle, a quadrangle, or a pentagon (see, FIGS. 2 to 4). In addition to the foregoing, the top of each protrusion 25 may be formed to be round, for example (see, FIG. 5). Furthermore, each protrusion 25 may have the same shape or a different shape.

It should be noted that the two or more protrusions 35 in the second chamber 30 are configured similarly to the two or more protrusions 25 in the first chamber 20. Furthermore, the first and/or second chamber(s) may be provided with one protrusion 25 and/or 35.

The adsorbent(s) 4 placed in the particular chamber(s) is formed as a pellet made from granular activated carbon. The pellet may have various shapes such as a substantially cylindrical shape and a spheroidal shape. Needless to say, the adsorbent 4 may be a granular adsorbent made from a material different from the activated carbon. On the other hand, the adsorbent 4 placed in a chamber other than the particular chamber(s) is not limited to the granular form, and various adsorbents may be placed.

### 2. Second Embodiment

### (1) Overview

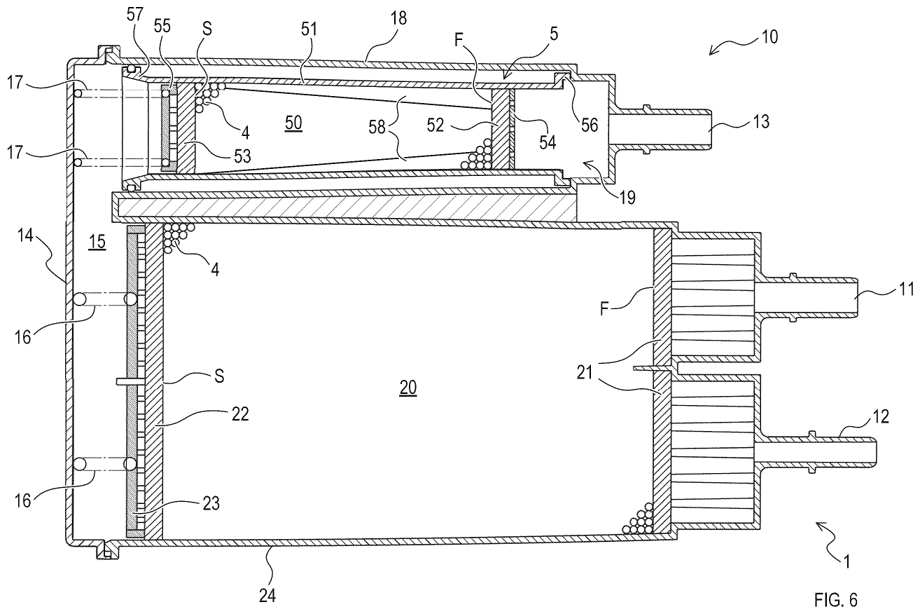

The canister 1 according to the second embodiment is different from that of the first embodiment in respect of a configuration of a second chamber 50 (see, FIG. 6). Specifically, in the canister 1 according to the second embodiment, there is arranged an inner case 5 inside the outer case 10. The inner case 5 includes therein the second chamber 50. Only the second chamber 50 is configured as the particular chamber. Needless to say, the first chamber 20 may be configured as the particular chamber. Hereinafter, a description is given to the configuration of the second chamber 50 in the canister 1 according to the second embodiment.

### (2) Accommodation Part

There is provided an accommodation part 18 (see, FIG. 6) in the outer case 10 of the canister 1, adjacent to the first chamber 20. As in the second chamber 30 according to the first embodiment, the accommodation part 18 has an elongated cylindrical shape extending from the lid side to the port side, and includes therein an accommodation space 19 so as to accommodate the inner case 5. It should be noted that the accommodation part 18 is not limited to be cylindrical, and may be in the form of a prism, for example. At an end (hereinafter, “first end”) on the port side of the accommodation part 18, there is provided the atmosphere port 13. Furthermore, the accommodation part 18 is connected to the communicating path 15 at an end (hereinafter, “second end”) thereof.

The inner case 5 is a circular tubular member that is made of resin and includes therein the second chamber 50. It should be noted that the inner case 5 is not limited to have a circular tubular shape, and may have a square tubular shape, for example. The inner case 5 includes a first end adjacent to the atmosphere port 13; and the atmosphere port 13 is provided substantially at an end (hereinafter, “first end F”) on the port side of the second chamber 50. Furthermore, the inner case 5 includes a second end adjacent to the communicating path 15; and the second chamber 50 is connected to the communicating path 15 at an end (hereinafter, “second end S”) on the lid side thereof. The inner case 5 comprises a side wall 51, filters 52 and 53, a partition wall plate 54, a grid 55, a contact portion 56, a flange 57, and two or more protrusions 58 (details will be described later).

The side wall 51 is a circular tubular portion, and includes the second chamber 50 therein. It should be noted that the side wall 51 is not limited to have a circular tubular shape, and may have a square tubular shape, for example. There are arranged the filters 52 and 53, respectively, at the first end F and the second end S of the second chamber 50. Between the filters 52 and 53, the granular adsorbent 4 is placed as in the first embodiment. The filter 52 at the first end F is supported from the atmosphere port 13 by the partition wall plate 54 having permeability. The second end S of the second chamber 50 is connected to the communicating path 15. Between the filter 53 on the lid side in the second chamber 50 and the communicating path 15, there is arranged the grid 55 that is configured to allow the fluid to pass therethrough. Between the grid 55 and the lid 14, there is arranged the coil spring 17. The coil spring 17 presses the grid 55 towards the port side.

The contact portion 56 is arranged so as to surround an opening located at the first end of the inner case 5. The contact portion 56 contacts the accommodation part 18 at a step portion provided in the vicinity of a first end of the accommodation part 18, and is supported by the step portion.

The flange 57 is arranged so as to surround an opening located at the second end of the inner case 5, and protrudes laterally. The flange 57 includes an end face contacting the accommodation part 18 at a second end of the accommodation part 18. Furthermore, a groove is provided in the end face of the flange 57 so as to surround the opening in the inner case 5, and there is arranged a sealing member (in one example, an O-ring) in the groove. The sealing member contacts the accommodation part 18.

### (3) Protrusion

The second chamber 50 is configured as the particular chamber provided with the two or more protrusions 58 protruding from an inner peripheral surface of the side wall 51 of the inner case 5 (FIG. 6). The two or more protrusions 58 are configured in the similar manner as the two or more protrusions 25 and 35 according to the first embodiment.

That is, the two or more protrusions 58 are made of resin, and formed integrally with the side wall 51 and thus, the inner case 5. Furthermore, as in the first embodiment, the two or more protrusions 58 are elongated portions like ribs, and extend along the flow directions of the fluid from the first end F to the second end S of the second chamber 50. In one example, each protrusion 58 extends from the first end F to the second end S of the second chamber 50. However, each protrusion 58 may be spaced apart from the first end F and/or the second end S.

Furthermore, as in the first embodiment, the two or more protrusions 58 are arranged in an aligned manner at substantially fixed intervals so as to circle around a lateral surface of the second chamber 50. Each protrusion 58 has a height shorter towards the second end S. However, the arrangement and the height of the two or more protrusions 58 are not limited hereto, and may be suitably determined. Furthermore, each protrusion 58 has a cross-sectional shape determined similarly to the first embodiment.

### 3. Third Embodiment

### (1) Overview

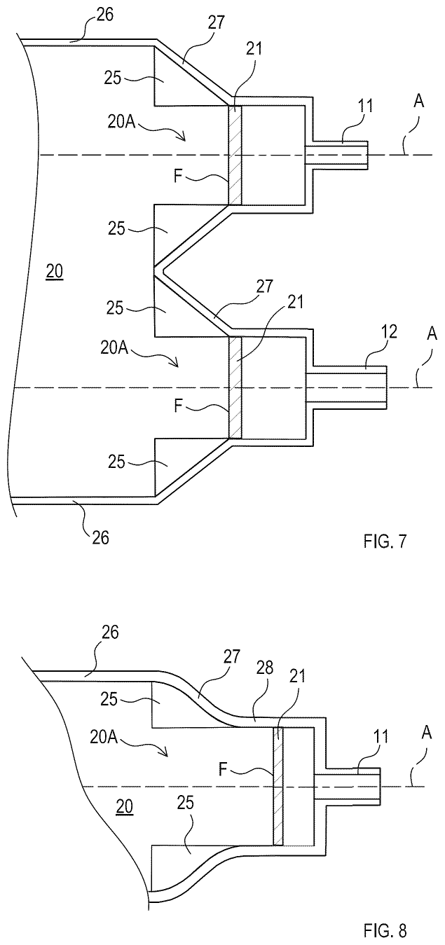

The canister 1 according to the third embodiment is different (see, FIG. 7) from that of the first embodiment in that two reduced parts 27 are provided to the first chamber 20, which is the particular chamber. The reduced parts 27 are located in the vicinity of the first end F of the first chamber 20 (in other words, the particular chamber). The reduced parts 27 are configured such that areas of cross-sections of the first chamber 20 orthogonal to the flow directions of the fluid are reduced towards the port side (in other words, the first end F).

In the third embodiment, the side wall 24 comprises a main part 26 and the two reduced parts 27. The main part 26 is a part that includes an end on the lid side of the side wall 24. The two reduced parts 27 are arranged at an end on the port side of the main part 26 in an aligned manner along the direction orthogonal to the flow directions of the fluid, and more specifically, a direction in which the first chamber 20 and the second chamber 30 are aligned.

The first end F of the first chamber 20 is configured as respective ends on the port side of the two reduced parts 27. These respective ends (in other words, first ends F) are provided with the inflow port 11 and the outflow port 12. Furthermore, each first end F of the first chamber 20 is provided with a filter 21.

The two reduced parts 27 are integrally formed with the side wall 24 and thus, the outer case 10. Each reduced part 27 is provided with the two or more protrusions 25. Hereinafter, a description is given to details of the reduced part(s) 27 and configurations of the two or more protrusions 25.

### (2) Details of Reduced Part(s)

The reduced part 27 corresponding to the inflow port 11 is arranged so as to extend towards the lid side (in other words, towards the second end S) from the first end F of the first chamber 20 to which the inflow port 11 is provided (see, FIG. 7). On the other hand, the reduced part 27 corresponding to the outflow port 12 is arranged so as to extend towards the lid side from the first end F of the first chamber 20 to which the outflow port 12 is provided.

Each reduced part 27 surrounds an area in the first chamber 20 in the vicinity of the corresponding port. Each reduced part 27 is tapered. That is, each reduced part 27 linearly extends in a cross-section containing an imaginary axis A that passes through the inflow port 11 or the outflow port 12 and extends in the flow directions of the fluid. Furthermore, each reduced part 27 tilts with respect to the flow directions of the fluid so as to come closer to the axis A towards the port side.

### (3) Protrusion

Each reduced part 27 has an inner peripheral surface provided with the two or more protrusions 25 protruding from the inner peripheral surface (see, FIG. 7). The two or more protrusions 25 are portions made of resin, and formed integrally with the reduced part 27 to which the two or more protrusions 25 are provided and thus, the side wall 24 and the outer case 10. It should be noted that the two or more protrusions 25 may be provided to one of the two reduced parts 27.

As in the first embodiment, each protrusion 25 is an elongated portion like a rib, and extends along the flow directions of the fluid from an end (in other words, the first end F) on the port side to an end on the lid side of a corresponding one of the reduced parts 27. However, each protrusion 25 is not limited to extend in the above range, and may reach or may not reach the main part 26 beyond the end on the lid side of the reduced part 27. Furthermore, each protrusion 25 may be spaced apart from the first end F of the reduced part 27. Still further, as in the first embodiment, the two or more protrusions 25 are arranged in an aligned manner at substantially fixed intervals so as to circle around a lateral surface of each reduced part 27.

Here, there is an area in the first chamber 20 that extends along the flow directions of the fluid towards the lid side from an end face that forms the first end F corresponding to the inflow port 11 or the outflow port 12. The area is referred to as “front area 20A”. The front area 20A is a columnar area having the same cross-sectional shape, as the end face, orthogonal to the extending direction of the protrusion 25. The top of each protrusion 25 extends along a boundary to the front area 20A. Needless to say, the shape of an end of each protrusion 25 may be suitably determined.

### (4) First Modified Example

The reduced part 27 may be located at a position in the vicinity of and slightly distanced from the first end F of the first chamber 20 (see, FIG. 8). Specifically, the reduced part 27 and a linear part 28 may be provided to the side wall 24 of the first chamber 20 so as to correspond to the inflow port 11 or the outflow port 12.

The linear part 28 is a tubular part, and arranged so as to extend substantially linearly along the flow directions of the fluid. That is, the linear part 28 has a substantially fixed cross-section orthogonal to the flow directions of the fluid. Furthermore, the cross-section has substantially the same shape as the end face forming the first end F of the first chamber 20.

The linear part 28 is arranged so as to extend towards the lid side from the first end F of the first chamber 20 to which the corresponding port is provided. The reduced part 27 is located at an end on the lid side of the linear part 28. The end on the lid side of the reduced part 27 is connected to the main part 26. That is, the linear part 28 and the reduced part 27 surround the area in the first chamber 20 in the vicinity of the corresponding port.

It should be noted that, the reduced part 27 is tapered in one example, and in a modified example of this example, both ends of the reduced part 27 in the flow directions of the fluid may be formed to be round.

As in the third embodiment, the inner peripheral surface of each reduced part 27 is provided with the two or more protrusions 25. As in the third embodiment, each protrusion 25 extends along the flow directions of the fluid from the end on the port side to the end on the lid side of the reduced part 27. The top of the protrusion 25 extends along the boundary to the front area 20A. Needless to say, the shape and the location to arrange the protrusion 25 are not limited hereto, and may be suitably determined.

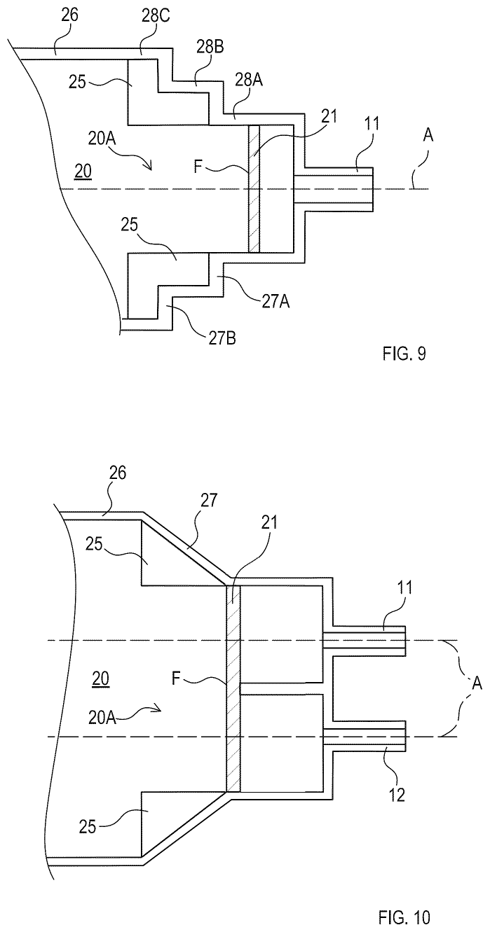

In addition to the aforementioned, the shape of the reduced part 27 is not limited to be tapered, and may be suitably determined. Specifically, for example, the reduced part 27 may be a part that is in the form of a step expanding in a direction substantially orthogonal to the flow directions of the fluid (see, FIG. 9).

Furthermore, the number of the reduced parts 27 and the linear parts 28 provided in a corresponding manner to the inflow port 11 or the outflow port 12 can be suitably determined. In one example, as illustrated in FIG. 9, first and second reduced parts 27A and 27B in the form of steps, and first to third linear parts 28A to 28C may be provided so as to correspond to the inflow port 11 or the outflow port 12. Specifically, the first linear part 28A is arranged so as to extend towards the lid side from the first end F of the first chamber 20 to which the corresponding port is provided, and the first reduced part 27A is arranged at an end on the lid side of the first linear part 28A. Furthermore, the second linear part 28B is arranged so as to extend towards the lid side from an end on an outer circumferential side of the first reduced part 27A, and the second reduced part 27B is arranged at an end on the lid side of the second linear part 28B. Still further, the third linear part 28C is arranged so as to extend towards the lid side from an end on an outer circumferential side of the second reduced part 27B, and the third linear part 28C is connected to the main part 26 at an end on the lid side thereof. That is, the first to third linear parts 28A to 28C, and the first and second reduced parts 27A and 27B surround the area in the first chamber 20 in the vicinity of the corresponding port.

As in the third embodiment, the two or more protrusions 25 are provided to inner peripheral surfaces of the second and third linear parts 28B and 28C and the first and second reduced parts 27A and 27B. Each protrusion 25 extends along the flow directions of the fluid from ends on the port side to ends on the lid side of these parts. The top of the protrusion 25 extends along the boundary to the front area 20A. Needless to say, the shape and the location to arrange each protrusion 25 are not limited hereto, and may be suitably determined.

It should be noted that the reduced part(s) 27 and the linear part(s) 28 described above may be arranged so as to correspond to one of the inflow port 11 or the outflow port 12, or provided to each of these ports. Furthermore, a reduced part and two or more protrusions may be similarly arranged to the side wall 34 of the second chamber 30 so as to correspond to the atmosphere port 13 in the second chamber 30. Still further, in the side wall 51 of the second chamber 50, which is formed by the inner case 5 according to the second embodiment, a reduced part and two or more protrusions may be similarly arranged so as to correspond to the atmosphere port 13.

### (5) Second Modified Example

The reduced part 27 may be arranged so as to correspond to the inflow port 11 and the outflow port 12 (see, FIG. 10). That is, the reduced part 27 may be arranged so as to extend towards the second end S from one first end F of the first chamber 20 to which the inflow port 11 and the outflow port 12 are provided. In other words, the reduced part 27 surrounds an area in the first chamber 20 in the vicinity of the inflow port 11 and the outflow port 12.

Furthermore, the reduced part 27 may be, for example, tapered. As in the third embodiment, the inner peripheral surface of the reduced part 27 is provided with the two or more protrusions 25. Each protrusion 25 extends along the flow directions of the fluid from the end on the port side to the end on the lid side of the reduced part 27. The top of the protrusion 25 extends along the boundary to the front area 20A. It should be noted that the front area 20A according to the second modified example means an area extending along the flow directions of the fluid towards the lid side from the end face forming the first end F of the first chamber 20 to which the outflow port 12 and the outflow port 12 are provided. Needless to say, the shape and the location to arrange each protrusion 25 are not limited hereto, and may be suitably determined.

It should be noted that, as in the first modified example, the second modified example may provide the linear part(s) 28 together with the reduced part(s) 27. The number of the reduced part(s) 27 and the number of the linear part(s) 28 may be suitably determined. Furthermore, the shape of the reduced part 27 is not limited to be tapered, and the reduced part 27 may be in the form of a step, for example. Even in this case, as in the third embodiment or the first modified example, the inner peripheral surface of the reduced part 27 may be provided with the two or more protrusions 25.

### 4. Effects

(1) In the above-described embodiments, there is a gap formed in the vicinity of the inner peripheral surface of the side wall in the particular chamber between each protrusion and the granular adsorbent. Therefore, a fluid flow can be encouraged in the vicinity of the inner peripheral surface. Furthermore, each protrusion is formed integrally with the outer case 10 or the inner case 5.

Therefore, such a configuration can reduce ventilation resistance in the canister 1 while preventing increase in the number of components. As a result, the canister 1 possesses improved capacity to desorb the evaporated fuel that has been adsorbed on the adsorbent (desorbing capacity). Moreover, since the desorbing capacity is improved, even a small quantity of adsorbents 4 can efficiently accumulate the evaporated fuel and thus, a capacity to adsorb the evaporated fuel (adsorbing capacity) is improved. Furthermore, the first chamber 20 is configured as the particular chamber having a relatively large volume. Accordingly, the desorbing capacity and the adsorbing capacity can be more effectively improved.

(2) Each protrusion 25, 35, and 58 extends along the flow directions of the fluid from the first end F of the particular chamber. This enables the fluid flow to be further encouraged in the vicinity of the inner peripheral surface of the particular chamber. As a result, the ventilation resistance in the canister 1 can be reduced.

(3) In the third embodiment, due to the shape of the reduced part 27 as well as the two or more protrusions, the fluid flow is encouraged inside the reduced part 27 in the particular chamber. Accordingly, the ventilation resistance in the canister 1 can be reduced.

(4) The protrusions 25, 35, and 58, respectively, are arranged in an aligned manner so as to circle around the lateral surfaces of the side walls 24, 34, and 51. Therefore, the fluid flow can be further encouraged in the vicinity of the inner peripheral surfaces of the side walls 24, 34, and 51. Accordingly, the ventilation resistance in the canister 1 can be further reduced.

(5) In a chamber provided with a port, an area having a relatively satisfactory fluid flow is considered to expand substantially in the form of a fan from the port along the flow directions of the fluid in a cross-section containing the axis A. In contrast, in the above-described embodiments, since the height of each protrusion 25, 35, and 58 is higher towards the first end F of the particular chamber, the protrusion can be arranged in an area having a relatively poor fluid flow. Therefore, the fluid flow can be encouraged in this area and as a result, the ventilation resistance in the canister 1 can be further reduced.

### 5. Other Embodiments

(1) The number of chambers provided in the canister 1 is not limited to two as in the above-described embodiments, and may be suitably determined. Furthermore, the chamber configured as the particular chamber may be suitably determined. The canister 1 may include a chamber without a port, and such a chamber may be configured as the particular chamber. For example, not only the second chamber, but also the first chamber may be configured with the inner case and such a first chamber may be configured as the particular chamber.

(2) In the above-described embodiments, the canister 1 may be configured by assembling two or more cases. Specifically, an outer peripheral surface of the canister 1 may be configured with the two or more cases, and each case may be provided therein with at least one chamber. In this case, the two or more protrusions in the particular chamber may be formed integrally with the case configuring the particular chamber.

(3) Two or more functions performed by a single element in the above-described embodiments may be achieved by two or more elements. A single function performed by a single element may be achieved by two or more elements. Two or more functions performed by two or more elements may be achieved by a single element. A single function performed by two or more elements may be achieved by a single element. Furthermore, a part of the configuration in the above-described embodiments may be omitted. Still further, at least a part of the configuration in the above-described embodiments may be added to or replaced with another configuration of the above-described embodiments.

### 6. Technical Ideas Disclosed in Present Disclosure

[Item 1]

A canister configured to be mounted in a vehicle with an engine, the canister comprising:
at least one chamber in which an adsorbent configured to adsorb an evaporated fuel is placed;
an inflow port configured to cause the evaporated fuel to flow from a fuel tank of the vehicle into the at least one chamber;
an atmosphere port configured to be open to atmosphere;
an outflow port configured to cause the evaporated fuel adsorbed on the adsorbent to flow out towards the engine by utilizing the atmosphere flowing in through the atmosphere port; and
a case forming a particular chamber in which a granular adsorbent is placed, the particular chamber being one of the at least one chamber, the case including:
a side wall extending from a first end of the particular chamber to a second end of the particular chamber in flow directions of a fluid, the side wall forming an inner peripheral surface of the particular chamber; and
at least one protrusion that is a part formed integrally with the side wall, the at least one protrusion protruding from an inner peripheral surface of the side wall

[Item 2]

The canister according to Item 1,
wherein one of the atmosphere port, or the inflow port and the outflow port is provided at the first end of the particular chamber, and
wherein the at least one protrusion extends along the flow directions from the first end of the particular chamber.

[Item 3]

The canister according to Item 1 or 2, further comprising an outer case, the outer case being a member that forms an outer peripheral surface of the canister and is provided therein with the at least one chamber,
wherein the case is a member arranged inside the outer case.

[Item 4]

The canister according to any one of Items 1 to 3, wherein two or more protrusions are arranged in an aligned manner in the inner peripheral surface of the side wall so as to circle around the particular chamber.

[Item 5]

The canister according to any one of Items 1 to 4,
wherein one of the atmosphere port, or the inflow port and the outflow port is provided at the first end of the particular chamber, and
wherein the at least one protrusion has a height, from the inner peripheral surface to a top of the protrusion, higher towards the first end.

[Item 6]

The canister according to any one of Items 1 to 5,
wherein one of the atmosphere port, or the inflow port and the outflow port is provided at the first end of the particular chamber,
wherein the side wall includes a reduced part located in a vicinity of the first end of the particular chamber,
wherein the reduced part is configured such that a cross-sectional area of the particular chamber orthogonal to the flow directions is reduced towards the first end, and
wherein the at least one protrusion is provided to the reduced part.

### 7. Corresponding Relationship of Terms

The outer case 10 according to the first and third embodiments, and the inner case 5 according to the second embodiment correspond to one example of the case.

What is claimed is:

1. A canister configured to be mounted in a vehicle with an engine, the canister comprising:
at least one chamber in which an adsorbent configured to adsorb an evaporated fuel is placed;
an inflow port configured to cause the evaporated fuel to flow from a fuel tank of the vehicle into the at least one chamber;
an atmosphere port configured to be open to atmosphere;
an outflow port configured to cause the evaporated fuel adsorbed on the adsorbent to flow out towards the engine by utilizing the atmosphere flowing in through the atmosphere port; and
a case forming a particular chamber in which a granular adsorbent is placed, the particular chamber being one of the at least one chamber,
the case including:
a side wall extending from a first end of the particular chamber to a second end of the particular chamber in flow directions of a fluid, the side wall forming an inner peripheral surface of the particular chamber; and
at least one protrusion that is a part formed integrally with the side wall, the at least one protrusion protruding from an inner peripheral surface of the side wall.

2. The canister according to claim 1,
wherein one of the atmosphere port, or the inflow port and the outflow port is provided at the first end of the particular chamber, and
wherein the at least one protrusion extends along the flow directions from the first end of the particular chamber.

3. The canister according to claim 1, wherein the at least one protrusion extends linearly.

4. The canister according to claim 1, further comprising an outer case, the outer case being a member that forms an outer peripheral surface of the canister and is provided therein with the at least one chamber,
wherein the case is a member arranged inside the outer case.

5. The canister according to claim 1, wherein two or more protrusions are arranged in an aligned manner in the inner peripheral surface of the side wall so as to circle around the particular chamber.

6. The canister according to claim 1,
wherein one of the atmosphere port, or the inflow port and the outflow port is provided at the first end of the particular chamber, and
wherein the at least one protrusion has a height, from the inner peripheral surface to a top of the protrusion, higher towards the first end.

7. The canister according to claim 1,
wherein one of the atmosphere port, or the inflow port and the outflow port is provided at the first end of the particular chamber,
wherein the side wall includes a reduced part located in a vicinity of the first end of the particular chamber,
wherein the reduced part is configured such that a cross-sectional area of the particular chamber orthogonal to the flow directions is reduced towards the first end, and
wherein the at least one protrusion is provided to the reduced part.

8. The canister according to claim 7, wherein the at least one protrusion extends at least from a first end of the reduced part to a second end of the reduced part in the flow directions.
